(19) United States
(12) Patent Application Publication
(10) Pub. No.: US 2022/0255721 A1
(43) Pub. Date: Aug. 11, 2022

(54) ACCELERATION UNIT AND RELATED APPARATUS AND METHOD

(71) Applicant: Alibaba Group Holding Limited, Georgetown (KY)

(72) Inventor: Xuanle REN, Shanghai (CN)

(21) Appl. No.: 17/578,319

(22) Filed: Jan. 18, 2022

(30) Foreign Application Priority Data
Jan. 19, 2021 (CN) 202110067073.2

(51) Int. Cl. H04L 9/00; G06F 9/50; G06F 9/30

(52) U.S. Cl. CPC H04L 9/008; G06F 7/57; G06F 9/30178; G06F 9/5027

(57) ABSTRACT

The present disclosure provides an acceleration unit, and a related apparatus and method. The acceleration unit includes: one or more number theoretic transform units adapted to perform number theoretic transform during homomorphic encryption; one or more arithmetic logic units adapted to perform an arithmetic operation during homomorphic encryption; and a scheduler adapted to assign an operation in a to-be-executed homomorphic encryption instruction to at least one of the one or more number theoretic transform units and at least one of the one or more arithmetic logic units. Embodiments of the present disclosure improve versatility, global performance, and scalability of deployment of homomorphic encryption hardware.

### TECHNICAL FIELD

The present disclosure relates to the chip field, and more specifically, to an acceleration unit, and a related apparatus and method.

### BACKGROUND

Big data provides huge opportunity for machine learning and model analytics. However, for privacy considerations, data cannot always be shared, resulting in data islands. For example, a platform needs to collect behavior preference data of users from user terminals, so as to perform big data analysis and allocate resources more properly. However, the users do not expect to expose their privacy. In this view, privacy computing based on homomorphic encryption emerges, intended to break the data islands and use data for computation and modeling without data privacy leakage. Homomorphic encryption refers to such an encryption function that allows encryption to be performed after in-loop add and multiply operations on plaintext, and then allows corresponding operations to be performed on the ciphertext after encryption, so as to obtain an equivalent result. Because of such good property, data processing can be outsourced to third parties without information leakage. An encryption function with homomorphic property means that two plaintexts a and b satisfy an encryption function DEC(En(a)⊙en(b))=a⊕b, where En is an encryption operation, Dec is a decryption operation, and ⊙ and ⊕ are operations on plaintext and ciphertex fields, respectively. When ⊕ represents addition, such encryption is referred to as addition homomorphic encryption; and when ⊕ represents multiplication, such encryption is referred to as multiplication homomorphic encryption.

Currently, homomorphic encryption can be implemented by a central processing unit (CPU), a graphics processing unit (GPU), a field programmable gate array (FPGA), and the like. Whichever is used, hardware of the CPU, GPU, and FPGA is designed for partial algorithms of homomorphic encryption, which impairs the global performance; in addition, hardware is designed for dedicated algorithms of homomorphic encryption, featuring poor versatility. Once algorithms of homomorphic encryption change, originally planned CPUs, GPUs or FPGAs may be no longer be applicable, and another type of hardware needs to be used.

### SUMMARY

In view of this, the present disclosure is intended to provide a hardware implementation for homomorphic encryption that features versatility, good global performance, and high scalability.

According to one aspect of the present disclosure, an acceleration unit is provided, including: one or more number theoretic transform units adapted to perform number theoretic transform during homomorphic encryption;

one or more arithmetic logic units adapted to perform arithmetic operations during homomorphic encryption; and

a scheduler adapted to assign operations in a to-be-executed homomorphic encryption instruction to at least one of the one or more number theoretic transform units and at least one of the one or more arithmetic logic units.

Optionally, the acceleration unit further includes:

an instruction buffer adapted to receive a control signal, where the control signal includes the to-be-executed homomorphic encryption instruction;

an instruction fetch unit adapted to fetch the to-be-executed homomorphic encryption instruction from the instruction buffer; and

an instruction decoding unit adapted to decode the to-be-executed homomorphic encryption instruction fetched by the instruction fetch unit and send to the scheduler the to-be-executed homomorphic encryption instruction that has been decoded.

Optionally, the control signal further includes an access memory address. The acceleration unit further includes: a memory interface for performing data transmission with a memory; and a direct memory access unit adapted to receive an access memory address sent by the instruction buffer, and indicate the memory interface to fetch, according to the access memory address, data required by the to-be-executed homomorphic encryption instruction.

Optionally, the scheduler divides the to-be-executed homomorphic encryption instruction into at least one of the following: modulus multiply operation, modulus add operation, number theoretic transform, inverse number theoretic transform, modulus switch, key switch, and rescale.

Optionally, the scheduler assigns the modulus multiply operation or modulus add operation to at least one of the one or more arithmetic logic units.

Optionally, the scheduler assigns the number theoretic transform to at least one of the one or more number theoretic transform units.

Optionally, for the inverse number theoretic transform, the scheduler decomposes the inverse number theoretic transform into a combination of a number theoretic transform and a modulus multiply operation, and assigns the number theoretic transform resulting from decomposition to at least one of the one or more number theoretic transform units, and assigns the modulus multiply operation resulting from decomposition to at least one of the one or more arithmetic logic units.

Optionally, for the modulus switch, the scheduler decomposes the modulus switch into a combination of a modulus add and a modulus multiply, and assigns the decomposition result to at least one of the one or more arithmetic logic units.

Optionally, for the key switch, the scheduler decomposes the key switch into a combination of a number theoretic transform, an inverse number theoretic transform, a modulus multiply, and a modulus switch, and assigns the decomposition result to at least one of the one or more number theoretic transform units or at least one of the one or more arithmetic logic units.

Optionally, for the rescale, the scheduler decomposes the rescale into a combination of a number theoretic transform, an inverse number theoretic transform, and a modulus switch, and assigns the decomposition result to at least one of the one or more number theoretic transform units or at least one of the one or more arithmetic logic units.

Optionally, at least one of the one or more number theoretic transform units includes:

a first polynomial coefficient storage subunit;

a second polynomial coefficient storage subunit;

a twiddle factor storage subunit adapted to store a twiddle factor for the number theoretic transform; and

a butterfly processing subunit adapted to perform first butterfly processing and second butterfly processing, where the first butterfly processing includes: reading a first polynomial coefficient pair from the first polynomial coefficient storage subunit, obtaining a twiddle factor corresponding to the first polynomial coefficient pair from the twiddle factor storage subunit, obtaining a second polynomial coefficient pair based on the first polynomial coefficient pair and the twiddle factor, and writing the second polynomial coefficient pair into the second polynomial coefficient storage subunit; and the second butterfly processing includes: reading a third polynomial coefficient pair from the second polynomial coefficient storage subunit, obtaining a twiddle factor corresponding to the third polynomial coefficient pair from the twiddle factor storage subunit, obtaining a fourth polynomial coefficient pair based on the third polynomial coefficient pair and the twiddle factor, and writing the fourth polynomial coefficient pair into the first polynomial coefficient storage subunit.

Optionally, at least one of the one or more number theoretic transform units further includes: a control unit adapted to control running of the first polynomial coefficient storage subunit, the second polynomial coefficient storage subunit, the twiddle factor storage subunit, and the butterfly processing subunit.

Optionally, the first polynomial coefficient storage subunit and the second polynomial coefficient storage subunit each include a plurality of banks, each bank has a corresponding index, the first polynomial coefficient pair and the third polynomial coefficient pair are from banks with a same index, and the second polynomial coefficient pair and the fourth polynomial coefficient pair are from banks with a same index.

Optionally, M banks are included in the first polynomial coefficient storage subunit or the second polynomial coefficient storage subunit, and there are m/2 butterfly processing subunits; and for a single butterfly processing subunit, indexes of a pair of banks for the first polynomial coefficient pair are the same as indexes of a pair of banks for the third polynomial coefficient pair, and a difference between indexes of two banks in the pair of banks is m/2; and indexes of a pair of banks for the second polynomial coefficient pair are the same as indexes of a pair of banks for the fourth polynomial coefficient pair, and indexes of two banks in the pair of banks are adjacent.

Optionally, after log₂ M times of first butterfly processing or second butterfly processing for, the control unit transposes the first polynomial coefficient storage subunit or the second polynomial coefficient storage subunit, and then the butterfly processing subunit performs the first butterfly processing or the second butterfly processing for log₂ M times again, where the transposing includes: fetching before-transposing polynomial coefficients queuing in a same serial number in the banks of the first polynomial coefficient storage subunit or the second polynomial coefficient storage subunit, and placing the after-transposing polynomial coefficients into one bank in an order of bank indexes.

Optionally, the butterfly processing subunit includes a first multi-path gating selector, a second multi-path gating selector, a third multi-path gating selector, a fourth multi-path gating selector, a first adder, a second adder, a first subtractor, a second subtractor, and a first multiplier.

Optionally, a first coefficient of the first polynomial coefficient pair or third polynomial coefficient pair is input to a first input terminal of the first multi-path gating selector, and after being added to a second coefficient of the first polynomial coefficient pair or third polynomial coefficient pair by the first adder, is input to a second input terminal of the first multi-path gating selector; one of the first input terminal and the second input terminal is selected by using a first gating signal of the first multi-path gating selector to connect to an output terminal; the second coefficient is input to a second input terminal of the third multi-path gating selector, and after subtraction is performed on the second coefficient and the first coefficient by the first subtractor, is input to a first input terminal of the third multi-path gating selector; and one of the first input terminal and the second input terminal is selected by using a third gating signal of the third multi-path gating selector to connect to an output terminal, and is multiplied with a corresponding twiddle factor by the first multiplier to obtain a product signal.

Optionally, a signal output from an output terminal of the first multi-path gating selector is input to a first input terminal of the second multi-path gating selector, and after being added to the product signal by the second adder, is input to a second input terminal of the second multi-path gating selector; one of the first input terminal and the second input terminal is selected by using a second gating signal of the second multi-path gating selector to connect to an output terminal as one coefficient of the second polynomial coefficient pair or fourth polynomial coefficient pair; the product signal is input to a second input terminal of the fourth multi-path gating selector, and after subtraction is performed by the second subtractor on the product signal and the signal output from the first multi-path gating selector, is input to a first input terminal of the fourth multi-path gating selector; and one of the first input terminal and the second input terminal is selected by using a fourth gating signal of the fourth multi-path gating selector to connect to an output terminal as the other coefficient of the second polynomial coefficient pair or fourth polynomial coefficient pair.

Optionally, the arithmetic logic unit includes a modulus adder, a modulus multiplier, a fifth multi-path gating selector, a sixth multi-path gating selector, and a seventh multi-path gating selector, where a first input signal is input to a first input terminal of the fifth multi-path gating selector and a first input terminal of the sixth multi-path gating selector, an output of the modulus adder is input to a second input terminal of the sixth multi-path gating selector, an output of the modulus multiplier is input to a second input terminal of the fifth multi-path gating selector, one of the first input terminal and the second input terminal of the fifth multi-path gating selector is selected by using a fifth gating signal of the fifth multi-path gating selector to connect to an output terminal, one of the first input terminal and the second input terminal of the sixth multi-path gating selector is selected by using a sixth gating signal of the sixth multi-path gating selector to connect to an output terminal; the output terminal of the fifth multi-path gating selector is connected to a first input terminal of the modulus adder, and a second input signal is input to a second input terminal of the modulus adder; an output terminal of the sixth multi-path gating selector is connected to a first input terminal of the modulus multiplier, and a third input signal is input to a second input terminal of the modulus multiplier; an output terminal of the modulus adder is connected to a first input terminal of the seventh multi-path gating selector, an output terminal of the modulus multiplier is connected to a second input terminal of the seventh multi-path gating selector, and one of the first input terminal and the second input terminal of the seventh multi-path gating selector is selected by using a seventh gating signal of the seventh multi-path gating selector to connect to an output terminal.

Optionally, the fifth gating signal is set to selecting a first input terminal, the seventh gating signal is set to selecting a first input terminal, and the arithmetic logic unit is adapted to perform a modulus add operation.

Optionally, the sixth gating signal is set to selecting a first input terminal, the seventh gating signal is set to selecting a second input terminal, and the arithmetic logic unit is adapted to perform a modulus multiply operation.

Optionally, the fifth gating signal is set to selecting a second input terminal, the sixth gating signal is set to selecting a first input terminal, the seventh gating signal is set to selecting a first input terminal, and the arithmetic logic unit is adapted to perform a modulus multiply operation and then perform a modulus add operation.

Optionally, the fifth gating signal is set to selecting a first input terminal, the sixth gating signal is set to selecting a second input terminal, the seventh gating signal is set to selecting a second input terminal, and the arithmetic logic unit is adapted to perform a modulus add operation and then perform a modulus multiply operation.

According to one aspect of the present disclosure, a computing apparatus is provided, including: a memory adapted to store a to-be-executed homomorphic encryption instruction;

the acceleration unit described above; and

a processing unit adapted to load the to-be-executed homomorphic encryption instruction, and assign the to-be-executed homomorphic encryption instruction to the acceleration unit for execution.

According to one aspect of the present disclosure, a system-on-a-chip is provided, including: the acceleration unit described above.

According to one aspect of the present disclosure, a data center is provided, including the computing apparatus described above.

According to one aspect of the present disclosure, a homomorphic encryption method is provided, including:

receiving a to-be-executed homomorphic encryption instruction;

decomposing the to-be-executed homomorphic encryption instruction into operations; and

assigning number theoretic transform included in the operation to at least one of one or more number theoretic transform units, and assigning arithmetic operation included in the operation to at least one of one or more arithmetic logic units.

In the present disclosure, through analysis and decomposition of various algorithms for homomorphic encryption, it is determined that various operations (including modulus add, modulus multiply, number theoretic transform/inverse number theoretic transform, key switch, modulus switch, rescale, and so on) decomposed from homomorphic encryption can be decomposed into number theoretic transform and arithmetic logic (modulus add, modulus multiply, and a combination thereof). Therefore, the number theoretic transform unit is introduced to execute number theoretic transform, and the arithmetic logic unit is introduced to execute arithmetic logic. Through scheduling by the scheduler, several number theoretic transform units and several arithmetic logic units can perform different tasks separately, or form a pipeline to execute different stages of a same task. In this way, different types of algorithms are efficiently compatible in this architecture. This improves global performance in comparison to the hardware designed for partial algorithms in the prior art, and features scalability and versatility in comparison to the hardware designed for dedicated algorithms in the prior art. Once the algorithms for homomorphic encryption change, the hardware structure can still remain unchanged because the new algorithms can be implemented based on various combinations of number theoretic transform and arithmetic logic. Therefore, the embodiments of the present disclosure provide a hardware implementation for homomorphic encryption that features versatility, good global performance, and high scalability.

### BRIEF DESCRIPTION OF DRAWINGS

The above and other objectives, features, and advantages of the present disclosure will become more apparent by describing the embodiments of the present disclosure with reference to the following accompanying drawings, in which:

FIG. 1 is a structural diagram of a data center to which an embodiment of the present disclosure is applied;

FIG. 2 is an internal structural diagram of a server in a data center according to an embodiment of the present disclosure;

FIG. 3 is an internal structural diagram of a processing unit and an acceleration unit inside a server according to an embodiment of the present disclosure;

FIG. 4 is an internal structure diagram of a number theoretic transform unit in FIG. 3;

FIG. 5 is an internal structure diagram of a butterfly processing subunit in FIG. 4;

FIG. 6 is an internal structure diagram of an arithmetic logic unit in FIG. 3;

FIG. 7 is a table listing functions that are executed by an arithmetic logic unit in different combinations of inputs of control terminals a, b, and c in FIG. 6;

FIG. 8 is a schematic diagram illustrating how a butterfly processing subunit fetches data between a first polynomial coefficient storage subunit and a second polynomial coefficient storage subunit according to an embodiment of the present disclosure; and

FIG. 9 is a flowchart of a homomorphic encryption method according to an embodiment of the present disclosure.

### DETAILED DESCRIPTION OF EMBODIMENTS

The following describes the present disclosure based on embodiments, but the present disclosure is not limited to the embodiments. In the following detailed descriptions of the present disclosure, some specific details are described in detail. Those skilled in the art can fully understand the present disclosure without the descriptions of the details. To avoid obscuring the essence of the present disclosure, well-known methods, processes, and procedures are not described in detail. In addition, the drawings are not necessarily drawn to scale.

The following terms are used in this specification.

Privacy computing: Big data provides huge opportunity for machine learning and model analytics. However, for privacy considerations, data cannot always be shared, resulting in data islands. For example, a platform needs to collect behavior preference data of users from user terminals, so as to perform big data analysis and allocate resources more properly. However, the users do not expect to expose their privacy. In this view, privacy computing emerges. The privacy computing is intended to use data for computation and modeling without data privacy leakage.

Homomorphic encryption: refers to such an encryption function that allows encryption to be performed after in-loop add and multiply operations on plaintext, and then allows corresponding operations to be performed on the ciphertext after encryption, so as to obtain an equivalent result. Because of such good property, data processing can be outsourced to third parties without information leakage. Encryption function with homomorphic property means that two plaintexts a and b satisfy an encryption function DEC(En(a)⊙en(b))=a⊕b, where En is an encryption operation, Dec is a decryption operation, and ⊙ and ⊕ are operations on plaintext and ciphertex fields, respectively. When ⊕ represents addition, such encryption is referred to as addition homomorphic encryption; and when ⊕ represents multiplication, such encryption is referred to as multiplication homomorphic encryption.

Acceleration unit: refers to a processing unit designed to improve a data processing speed in some special-purpose fields (for example, image processing and various operations for processing deep learning networks), so as to address the problem of low efficiency of conventional processing units in the special-purpose fields. The acceleration unit is also referred to as an artificial intelligence (AI) processing unit, including a central processing unit (CPU), a graphics processing unit (GPU), a general-purpose graphics processing unit (GPGPU), a field programmable gate array (FPGA), an application specific integrated circuit (ASIC), and dedicated intelligent acceleration hardware (for example, a neural-network processing unit NPU or a hardware accelerator). The acceleration unit used in the embodiments of the present disclosure is designed for the field of homomorphic encryption, and improves versatility and global performance of homomorphic encryption.

Processing unit: refers to a unit for conventional processing (not used for image processing and processing of complex operations such as full connection calculations in various deep learning networks) in servers of the data center. In addition, the processing unit is also responsible for scheduling functions of the acceleration unit and the processing unit itself, and for task assigning for the acceleration unit and the processing unit itself. The processing unit may be a plurality of forms, such as a processing unit (CPU), an application-specific integrated circuit (ASIC), or a field programmable gate array (FPGA).

Number theoretic transform (Number Theoretic Transform): refers to a fast algorithm for convolution calculation. The algorithm itself is similar to fast Fourier transform, but different from a fast Fourier transform whose twiddle factor is a complex value, a number theoretic transform has a twiddle factor that is an integer of mod P. In other words, fast Fourier transform is transform defined on the complex plane while number theoretic transform is transform defined on a polynomial loop.

Number theoretic transform is widely used in homomorphic encryption. In homomorphic encryption, the plaintext or ciphertext is embodied in polynomial coefficients. The polynomial coefficients are connected sequentially to form a polynomial loop. During encryption, the plaintext is first processed into a polynomial coefficient, and the encryption process is performing operational processing on the coefficient to obtain another value, and the decryption process is changing the another value back to the original value. Various processing on the ciphertext is also implemented by various transform on a polynomial coefficient of the ciphertext. Regardless of transform of a plaintext coefficient or ciphertext coefficient, an important transform is number theoretic transform.

Inverse number theoretic transform: refers to an inverse process of the number theoretic transform described above. Inverse number theoretic transform may be considered as a combination of a number theoretic transform and a modulus multiply operation.

Arithmetic operations during encryption: generally refer to modulus operations, mainly including modulus add and modulus multiply operations, and combinations of modulus add and modulus multiply operations. Mod is transliteration of “Mod”, and modulus operations are typically applied to programming. Mod means finding a remainder. The mod operation is widely used in number theoretic and programming design, from distinguishing odd and even numbers to determining prime numbers, from mod power operation to calculation of the maximum number of conventions, and from congruence modulo to Caesar cipher. The modulus add operation refers to such an operation that (a+b) % p, which finds a remainder of a sum of (a+b) divided by p, is used as a polynomial coefficient after transform. In other words, (a+b)=kp+r, where k, p, and r are positive integers. The modulus multiply operation refers to such an operation that (a*b) % p, which finds a remainder of a product of a*b divided by p is used as a polynomial coefficient after transform. In other words, (a*b)=kp+r, where k, p, and r are positive integers.

Modulus switch (Modulus Switch): In the homomorphic encryption technology, ciphertext exists in a form of polynomial coefficients. These coefficients are a residue class of mod another number, and the purpose of modulus switch is to replace a modulus corresponding to these coefficients with another modulus. For example, these coefficients are originally a residue class of mod 5, and become a residue class of mod 3 after modulus switch. Therefore, through modulus switch, the polynomial coefficient changes. The modulus switch can be decomposed into a combination of basic modulus add and modulus multiply operations.

Key Switch (Key Switch): In the homomorphic encryption technology, a polynomial coefficient of the ciphertext is obtained through encryption on the plaintext by using a specified key. Key switch allows processing on the ciphertext to change its key to another key. Such processing requires an additional key for replacement, referred to as a key-switch key (key-switch key). After key switch, the polynomial coefficient of the ciphertext is changed to another polynomial coefficient of the ciphertext. Key switch can be decomposed into a combination of a number theoretic transform, an inverse number theoretic transform, a modulus multiply, and a modulus switch.

Rescale (Rescale): A number a (0≤a≤M) of mod M and a scaling factor r are given; rescale means dividing a by r, and a range of a number a′=a/r after scaling is changed to 0≤a<m/r. After rescaling, the polynomial coefficient of the ciphertex is all changed to the original 1/r. A rescale may be decomposed into a combination of a number theoretic transform, an inverse number theoretic transform, and a modulus switch.

Scheduling: Operations in an instruction are sorted in a computing order in the instruction. In addition, based on load of to-be-scheduled units (which are number theoretic transform units and arithmetic logic units in the embodiments of the present disclosure), the operations are assigned to appropriate units for execution. The entire process is referred to as scheduling.

Butterfly processing: Number theoretic transform may be considered as a process of repeated processing on polynomial coefficients of a polynomial loop according to the same rule, for example, fetching polynomial coefficients in two fixed positions of the polynomial loop, processing the polynomial coefficients by using a twiddle factor, to obtain a pair of new polynomial coefficients, and then placing the pair of new polynomial coefficients to other two fixed positions of the polynomial loop, for example, fetching the 1st polynomial coefficient and the 5th polynomial coefficient from the polynomial loop, and after processing by using a twiddle factor, placing resulting polynomial coefficients to positions of the 1st polynomial coefficient and the 2nd polynomial coefficient of the polynomial loop. After all the polynomial coefficients are fetched, processed by using the twiddle factor, and put back to positions of other polynomial coefficients of the polynomial loop, the foregoing process is repeated, that is, fetching the 1st polynomial coefficient and the 5th polynomial coefficient from a new polynomial loop, and after processing by using a twiddle factor, placing resulting polynomial coefficients to positions of the 1st polynomial coefficient and the 2nd polynomial coefficient of the polynomial loop. Butterfly processing is created for repeated execution of such an operation. To be specific, two storage subunits are set for the polynomial loop, and after polynomial coefficients are fetched from predetermined positions of the first storage subunit and processed by using a twiddle factor, resulting polynomial coefficients are placed into other predetermined positions of the second storage subunit. Conversely, after polynomial coefficients are fetched from predetermined positions of the second storage subunit and processed by using a twiddle factor, resulting polynomial coefficients are placed into other predetermined positions of the first storage subunit. In this way, the process of repeated processing by using the twiddle factor in number theoretic transform is simplified, and the repeated process is considered as rearrangement operation for different storage subunits in the same process. Operations of fetching and processing of a polynomial coefficient, and writing a result into a different polynomial coefficient position each time are called butterfly processing.

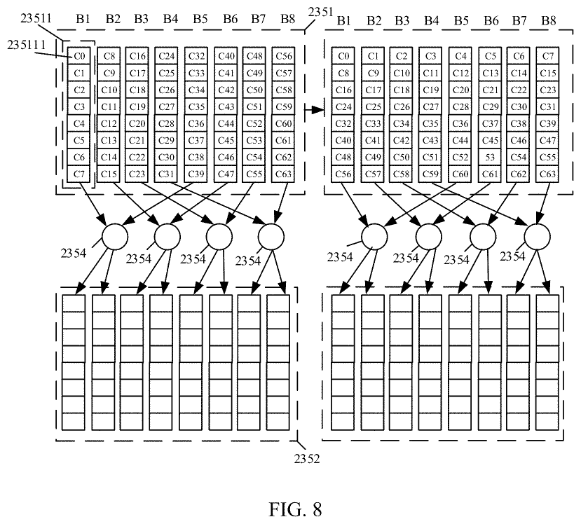

Bank: refers to a storage module, where storage modules each store one memory queue sequentially, for example, a queue formed by polynomial coefficients in the present disclosure. In the example shown in FIG. 8, the first polynomial coefficient storage subunit 2351 or the second polynomial coefficient storage subunit 2352 each include several banks 23511, and each bank stores a queue of 8 polynomial coefficients. When the ciphertext is expressed as a polynomial of 64 polynomial coefficients, the 64 polynomial coefficients may be distributed in 8 memories, and 8 polynomial coefficients are stored in each bank.

Transposing: Rows of an array become columns of the array, and columns of the array become rows of the array. When the plaintext or ciphertext is expressed as polynomial coefficients of a polynomial, the polynomial coefficients are stored in a plurality of banks described above, and each bank stores part of the polynomial coefficients. In this context, transposition means forming a new column (bank) by using polynomial coefficients in the same positions (with the same indexes) of all banks, so that each new column (each bank) contains one polynomial coefficient of each original bank, that is, exchanging rows and columns of polynomial coefficient arrays stored in each bank.

Multi-path gating selector: refers to a device that is connected to a plurality of input terminals, and in response to a gating signal, connects one of the plurality of input terminals to an output terminal for output.

System-on-a-chip (SOC: System-on-a-chip) is a technology that integrates a complete system on a single chip, and grouping all or part of necessary electronic circuits. The so-called complete system typically includes a central processing unit (CPU) or an acceleration unit, a memory, a peripheral circuit, and so on. SoC is developed along with other technologies, such as silicon on insulator (SOI), and can provide enhanced clock frequencies, thereby reducing power consumption of microchips.

Data Center

The data center is a network of specific devices for global collaboration, and is used to deliver, accelerate, display, calculate, and store data information on the Internet network infrastructure. In the future development, the data center will also become an asset of business competition. With wide application of the data center, artificial intelligence is increasingly applied to the data center. As an important technique for artificial intelligence, deep learning has been significantly applied to big data analysis and computation of the data center.

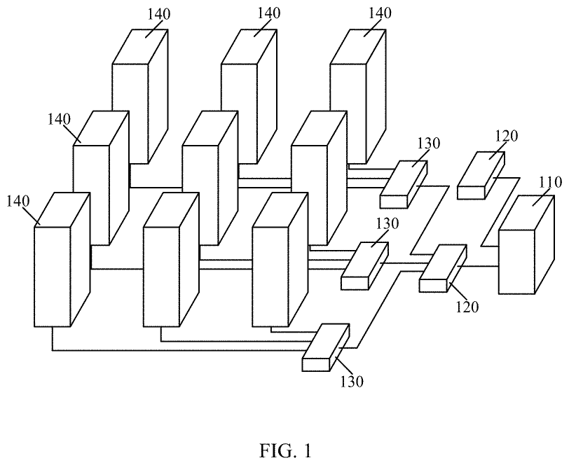

In a conventional large-scale data center, a typical network structure is shown in FIG. 1, that is, a hierarchical inter-networking model (hierarchical inter-networking model). This model contains the following parts:

Server 140: The servers 140 are processing and storage entities of the data center, and processing and storage of massive data in the data center are completed by these servers 140.

Access switch 130: The access switch 130 is a switch for the server 140 to access the data center. One access switch 130 is connected to a plurality of servers 140. The access switches 130 are generally located at the top of a rack, and therefore are also referred to as top of rack (Top of Rack) switches. The access switches 130 are physically connected to the server.

Aggregation switch 120: Each aggregation switch 120 is connected to a plurality of access switches 130, and also provides other services, such as firewall, intrusion detection, and network analysis.

Core switch 110: The core switch 110 provides high speed forwarding for packets into or out of the data center, and provides connectivity for the aggregation switch 120. The network of the entire data center is divided into an L3 routing network and an L2 routing network, and the core switch 110 usually provides a resilient L3 routing network for the network of the entire data center.

Generally, the aggregation switch 120 is a split point of the L2 and L3 routing networks, the L2 network below the aggregation switch 120 and the L3 network above the aggregation switch 120. Each group of aggregation switches manage a point of delivery (POD, Point Of Delivery), and each POD is a stand-alone virtual local area network (VLAN). Migration of a server within the POD does not require modification of an IP address and a default gateway because one POD corresponds to one L2 broadcast domain.

A spanning tree protocol (STP, Spanning Tree Protocol) is usually generated between the aggregation switch 120 and the access switch 130. With the STP, only one aggregation switch 120 is usable for one VLAN network, and other aggregation switches 120 can be used only in case of faults. That is, horizontal expansion cannot be implemented from the perspective of the aggregation switch 120, because only one can work even if a plurality of aggregation switches 120 are added.

The embodiments of the present disclosure may be applied to scenarios such as privacy preserving multi-party computing, privacy preserving machine learning, and on-terminal prediction.

In application of privacy preserving multi-party computing, one server 140 in FIG. 1 performs computing. Multi-party computing needs to use multi-party data, including plaintext data of some parties and ciphertext data of other parties. Such plaintext data or ciphertext data may be from some other servers 140 in FIG. 1. Through the access switch 130, the aggregation switch 120, and the core switch 110, a server 140 for computing is connected to a server 140 in which the plaintext data or ciphertext data is located; obtains the plaintext data or ciphertext data from the server 140 in which the data is located; and performs homomorphic encryption computing by using the following hardware structure in the embodiments of this disclosure.

Server

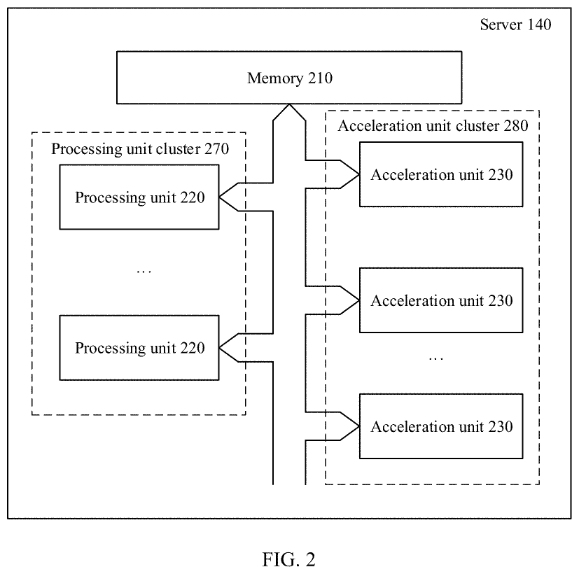

The server 140 is a real processing device of the data center. FIG. 2 is a block diagram of an internal structure of a server 140. The server 140 includes a bus-connected memory 210, a processing unit cluster 270, and an acceleration unit cluster 280. The processing unit cluster 270 includes a plurality of processing units 220. The acceleration unit cluster 280 includes a plurality of acceleration units 230. The acceleration unit 230 is a processing unit designed to improve a data processing speed in special-purpose fields. The acceleration unit is also referred to as an artificial intelligence (AI) processing unit, including a central processing unit (CPU), a graphics processing unit (GPU), a general-purpose graphics processing unit (GPGPU), a field programmable gate array (FPGA), an application specific integrated circuit (ASIC), and dedicated intelligent acceleration hardware (for example, a neural-network processing unit NPU or a hardware accelerator).

In an architecture designed for the conventional processing unit 220, the control unit and the memory occupy a very large space in the architecture, and therefore the computing unit occupies insufficient space. In this case, the computing unit implements logic control very effectively, but is inefficient in large-scale parallel computing. Therefore, various dedicated acceleration units 230 are developed to more efficiently improve a computing speed for calculations in different functions and different fields. In the embodiments of the present disclosure, the acceleration unit 230 is a hardware accelerator for performing homomorphic encryption computing. The data and intermediate results in the computing are closely linked throughout the calculation process, and are usually used. With an existing processing unit architecture, because an in-core memory capacity of the processing unit is so small that out-of-core memories need to be frequently accessed, resulting in inefficient processing. However, the dedicated acceleration unit has a large number of structures such as internal buffers, thereby avoiding frequent access to out-of-core memories and greatly improving processing efficiency and computing performance. In addition, during design of the acceleration unit 230 in the embodiments of the present disclosure, versatility and overall properties for homomorphic encryption computing have been considered. Details will be described in detail below.

The acceleration unit 230 needs to be scheduled by the processing unit 220. Homomorphic encryption instructions are stored in the memory 210. These instructions are deployed in one acceleration unit 230 by one processing unit 220 in FIG. 2 when needed. That is, the processing unit 220 can send, to the acceleration unit 230 by using an instruction, an address at which parameters of an homomorphic encryption instruction are located in the memory 210. During homomorphic encryption computing, the acceleration unit 230 performs addressing on the parameters in the memory 210 based on the address of the parameters in the memory 210, and temporarily stores the parameters in its internal buffer for homomorphic encryption computing.

Internal Structures of the Processing Unit and Acceleration Unit

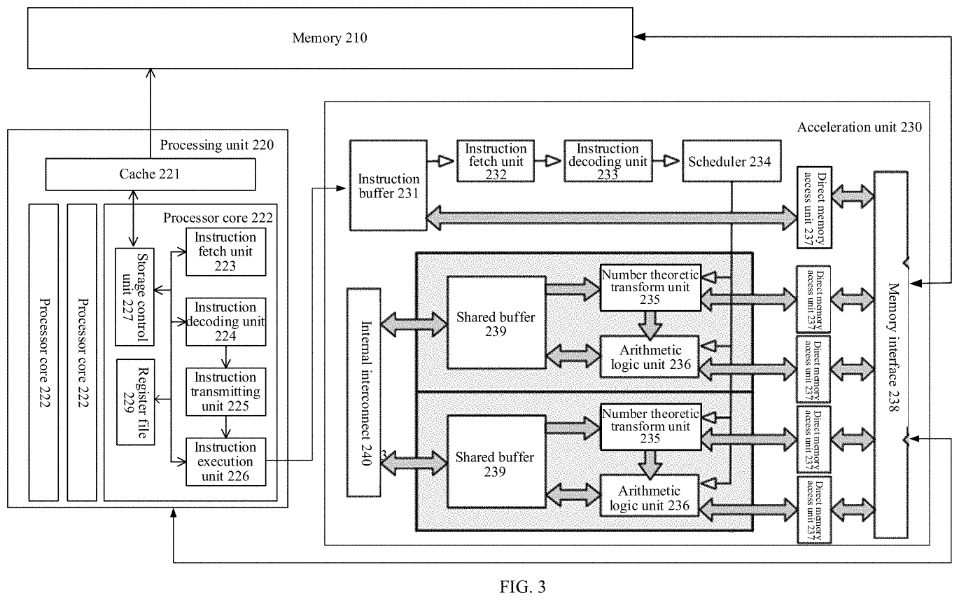

With reference to an internal structural diagram of the processing unit 220 and the acceleration unit 230 in FIG. 3, the following describes in detail how the processing unit 220 schedules the acceleration unit 230 and the processing unit 220 for working.

As shown in FIG. 3, the processing unit 220 includes a plurality of processor core 222 and a cache 221 shared by the plurality of processor core 222. Each processor core 222 includes an instruction fetch unit 223, an instruction decoding unit 224, an instruction sending unit 225, and an instruction execution unit 226.

The instruction fetch unit 223 is adapted to transfer a to-be-executed instruction from the memory 210 to an instruction register (which may be one register for storing instructions in a register file 229 shown in FIG. 3), and receives a next instruction fetch address or calculates a next instruction fetch address according to an instruction fetch algorithm. For example, the instruction fetch algorithm includes address incrementing or decrementing based on an instruction length.

After an instruction is fetched, the processing unit 220 enters an instruction decoding phase. The instruction decoding unit 224 decodes the fetched instruction in a predetermined instruction format, to obtain operand obtaining information required for the fetched instruction, and prepare for operation of the instruction execution unit 226 is prepared. For example, the operand obtaining information points to an immediate, register, or other software/hardware capable of providing source operands.

The instruction sending unit 225 is located between the instruction decoding unit 224 and the instruction execution unit 226, and is adapted to perform scheduling and control of instructions, so as to efficiently assign the instructions to different instruction execution units 226, implementing parallel operation of a plurality of instructions.

After the instruction sending unit 225 sends the instruction to the instruction execution unit 226, the instruction execution unit 226 starts to execute the instruction. However, if determining that the instruction should be performed by an acceleration unit, the instruction execution unit 226 forwards the instruction to a corresponding acceleration unit for execution. For example, if the instruction is a to-be-executed homomorphic encryption instruction, the instruction execution unit 226 does not perform the instruction, but instead the instruction sending unit 225 sends the instruction through a bus to the acceleration unit 230 for execution.

In the prior art, the acceleration unit 230 for accelerating the homomorphic encryption computing may be implemented in three manners: a central processing unit (CPU), a graphics processing unit (GPU), or a field programmable gate array (FPGA). The CPU scheme implements more complete operators in homomorphic encryption, including key generation, encryption and decryption, key switch, modulus switch, and the like. In some scenarios, a multi-thread function provided by the CPU is also used. The GPU scheme makes full use of parallel processing of the GPU, and GPU acceleration is performed on parallel-prone operators (number theoretic transform or the like) during homomorphic encryption. Experiments show that this scheme can accelerate several times to tens of times than the CPU scheme. The FPGA scheme implements homomorphic encryption algorithms in the FPGA, making full use of hardware pipeline and high throughput. However, regardless of the CPU, GPU or FPGA scheme, the disadvantages lie in that all the schemes are designed for partial algorithms, deteriorating global performance. The hardware is implemented for dedicated algorithms, featuring poor versatility.

In the embodiment of the present disclosure, a structure of the accelerator unit 230 in FIG. 3 is used to avoid the disadvantages in the foregoing prior-art hardware implementation, and features high versatility, good global performance, and high scalability.

As shown in FIG. 3, the acceleration unit 230 includes an instruction buffer 231, an instruction fetch unit 232, an instruction decoding unit 233, a scheduler 234, a number theoretic transform unit 235, an arithmetic logic unit 236, a direct memory access unit 237, a memory interface 238, a shared buffer 239, an internal interconnect 240, and so on. There may be one or more number theoretic transform units 235, and there may be one or more arithmetic logic units 236.

The instruction execution unit 226 sends to the acceleration unit 230 not only a to-be-executed homomorphic encryption instruction but also an access memory address at which data required by the to-be-executed homomorphic encryption instruction is stored in the memory 210. The instruction execution unit 226 may combine the to-be-executed homomorphic encryption instruction and the access memory address into a control signal, and sends the control signal to the acceleration unit 230.

The control signal first enters the instruction buffer 231 of the acceleration unit 230. The instruction buffer 231 caches the to-be-executed homomorphic encryption instruction, and also sends the access memory address to the direct memory access unit 237. The direct memory access unit 237 receives the access memory address, and indicates the memory interface 238 for performing data transmission with the memory 210 to fetch, from the memory 210 according to the access memory address, the data required by the to-be-executed homomorphic encryption instruction. In this case, the number theoretic transform unit 235 and the arithmetic logic unit 236 can obtain the data directly from the direct memory access unit 237 during actually instruction execution.

The instruction fetch unit 232 fetches the to-be-executed homomorphic encryption instruction from the instruction buffer 231, and sends the instruction to the instruction decoding unit 233. The instruction decoding unit 233 decodes the to-be-executed homomorphic encryption instruction fetched by the instruction fetch unit 232 and sends to the scheduler 234 the to-be-executed homomorphic encryption instruction that has been decoded. It should be noted that the instruction decoding unit 224 in the processing unit 220 has decoded the to-be-executed homomorphic encryption instruction, and a cause for re-decoding herein is that an instruction set understandable for the acceleration unit 230 is different from an instruction set understandable for the processing unit 220. Therefore, re-decoding needs to be performed to decode the instruction into an instruction set that can be understood by the acceleration unit 230.

As described above, various calculations for homomorphic encryption include modulus add, modulus multiply, number theoretic transform/inverse number theoretic transform, key switch, modulus switch, rescale, and so on. Concepts of modulus add, modulus multiply, number theoretic transform/inverse number theoretic transform, key switch, modulus switch, and rescale have been described above in term interpretation. The modulus add and modulus multiply operations are arithmetic logic operations, and can be executed by at least one of the one or more arithmetic logic units 236. The number theoretic transform can be executed by at least one of the one or more number theoretic transform units 235. The inverse number theoretic transform may be considered as a combination of a number theoretic transform and a modulus multiply operation, where the number theoretic transform can be executed by at least one of the one or more number theoretic transform units 235, and the modulus multiply operation can be executed by at least one of the one or more arithmetic logic units 236. The modulus switch may be considered as a combination of a modulus add and a modulus multiply, and can be executed by at least one of the one or more arithmetic logic units 236. The key switch may be considered as a combination of a number theoretic transform, an inverse number theoretic transform, a modulus multiply, and a modulus switch, where the inverse number theoretic transform and modulus switch can be further decomposed, and is finally executed by at least one of the one or more number theoretic transform units 235 and by at least one of the one or more arithmetic logic units 236. The rescale may be considered as a combination of a number theoretic transform, an inverse number theoretic transform, and a modulus switch, where the inverse number theoretic transform and modulus switch can be further decomposed, and is finally executed by at least one of the one or more number theoretic transform units 235 and by at least one of the one or more arithmetic logic units 236. It can be learned from the foregoing that all operations included in the to-be-executed homomorphic encryption instruction can be ultimately decomposed into operations to be executed by at least one of the one or more number theoretic transform units 235 or by at least one of the one or more arithmetic logic units 236. The scheduler 234 is a unit that assigns all the operations included in the to-be-executed homomorphic encryption instruction to at least one of the one or more number theoretic transform units 235 or at least one of the one or more arithmetic logic units 236 for execution. The specific practice is to divide the to-be-executed homomorphic encryption instruction into a combination of at least one of these operations: modulus multiply operation, modulus add operation, number theoretic transform, inverse number theoretic transform, modulus switch, key switch, and rescale; decompose the modulus multiply operation, modulus add operation, number theoretic transform, inverse number theoretic transform, modulus switch, key switch, and rescale according to the foregoing rule; and then assign the resulting operations to at least one of the one or more number theoretic transform units 235 and at least one of the one or more arithmetic logic units 236 for execution. The foregoing rule for decomposition is stored inside the scheduler 234.

Regardless of which homomorphic encryption algorithm, the algorithm can be finally decomposed into different combinations of number theoretic transform and arithmetic logic (modulus add, modulus multiply, and a combination thereof). In the embodiments of the present disclosure, the number theoretic transform unit 235 is introduced to execute number theoretic transform, and the arithmetic logic unit 236 is introduced to execute arithmetic logic. Through scheduling by the scheduler 234, several number theoretic transform units 235 and several arithmetic logic units 236 can perform different tasks separately, or form a pipeline to execute different stages of a same task. In this way, different types of algorithms are efficiently compatible in the embodiments of the present disclosure, improving global performance, scalability, and versatility.

In addition to the instruction buffer 231 storing the to-be-executed homomorphic encryption instruction, the number theoretic transform unit 235 and arithmetic logic unit 236 may each include a local buffer for storing data required by the number theoretic transform unit 235 during number theoretic transform as well as resulting intermediate data, and for storing data required by the arithmetic logic unit 236 during modulus add and modulus multiply operation as well as resulting intermediate data, respectively. When the data required for number theoretic transform, modulus add, and modulus multiply and the resulting intermediate data are too large to be stored in the local buffer, the data and the resulting intermediate data can be stored in the shared buffer 239 shared by the number theoretic transform unit 235 and the arithmetic logic unit 236. The shared buffers 239 communicate with each other through the internal interconnect 240, for data sharing. The acceleration unit 230 in the embodiments of the present disclosure has a large number of local buffers, shared buffers 239, and the like, to avoid frequent access to out-of-core memory 210, thereby greatly improving the processing efficiency of homomorphic encryption and improving computing performance.

Internal Structure of the Number Theoretic Transform Unit

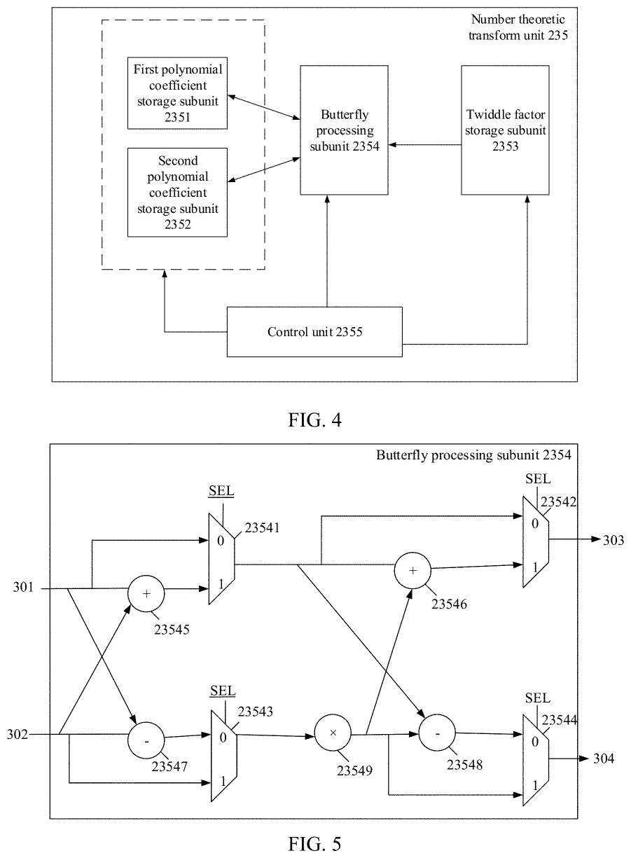

Number theoretic transform may be considered as a process of repeated processing on polynomial coefficients of a polynomial loop according to the same rule, for example, fetching polynomial coefficients in two fixed positions of the polynomial loop, processing the polynomial coefficients by using a twiddle factor, to obtain a pair of new polynomial coefficients, and then placing the pair of new polynomial coefficients to other two fixed positions of the polynomial loop, for example, fetching the 1st polynomial coefficient and the 5th polynomial coefficient from the polynomial loop, and after processing by using a twiddle factor, placing resulting polynomial coefficients to positions of the 1st polynomial coefficient and the 2nd polynomial coefficient of the polynomial loop. A new polynomial loop is generated after all the polynomial coefficients are processed in the foregoing manner. Then, the foregoing process is repeated, that is, fetching the 1st polynomial coefficient and the 5th polynomial coefficient from a new polynomial loop, and after processing by using a twiddle factor, placing resulting polynomial coefficients to positions of the 1st polynomial coefficient and the 2nd polynomial coefficient of the polynomial loop. Butterfly processing is created for repeated execution of such an operation. As shown in FIG. 4, a first polynomial coefficient storage subunit 2351 and a second polynomial coefficient storage subunit 2352 are provided in a number theoretic transform unit 235. The first polynomial coefficient storage subunit 2351 stores polynomial coefficients of an original polynomial loop. After being fetched from a predetermined position, a polynomial coefficient is processed by using a twiddle factor and is placed into another predetermined position of the second polynomial coefficient storage subunit 2352. In this way, new polynomial coefficients are obtained. Conversely, after being fetched from a predetermined position of the second polynomial coefficient storage subunit 2352, a polynomial coefficient is processed by using a twiddle factor and is placed into another predetermined position of the first polynomial coefficient storage subunit 2351. In this way, rearrangement processing is repeated until a predetermined requirement is satisfied, and the new polynomial coefficients stored in the first polynomial coefficient storage subunit 2351 or the second polynomial coefficient storage subunit 2352 is a result of number theoretic transform. Operations of fetching and processing of a polynomial coefficient, and writing a result into a different polynomial coefficient position each time are called one butterfly processing, which is processed by the butterfly processing subunit 2354. The number theoretic transform unit 235 further includes a twiddle factor storage subunit 2353 for storing a twiddle factor used in the butterfly processing. The twiddle factor is set in advance and stored in the twiddle factor storage subunit 2353. The number theoretic transform unit 235 may further include a control unit 2355 for controlling running of the first polynomial coefficient storage subunit 2351, the second polynomial coefficient storage subunit 2352, the twiddle factor storage subunit 2353, and the butterfly processing subunit 2354.

The butterfly processing can be divided into first butterfly processing and second butterfly processing.

The first butterfly processing includes: reading a first polynomial coefficient pair from the first polynomial coefficient storage subunit 2351, obtaining a twiddle factor corresponding to the first polynomial coefficient pair from the twiddle factor storage subunit 2353, obtaining a second polynomial coefficient pair based on the first polynomial coefficient pair and the twiddle factor, and writing the second polynomial coefficient pair into the second polynomial coefficient storage subunit 2352. In the foregoing example, the 1st polynomial coefficient and the 5th polynomial coefficient of the first polynomial coefficient storage subunit 2351 are fetched and used as the first polynomial coefficient pair, and after being processed by using the twiddle factor, become the second polynomial coefficient pair. The second polynomial coefficient pair is placed back to positions of the 1st polynomial coefficient and the 2nd polynomial coefficient of the second polynomial coefficient storage subunit 2352. This belongs to the first butterfly processing.

The second butterfly processing includes: reading a third polynomial coefficient pair from the second polynomial coefficient storage subunit 2352, obtaining a twiddle factor corresponding to the third polynomial coefficient pair from the twiddle factor storage subunit 2353, obtaining a fourth polynomial coefficient pair based on the third polynomial coefficient pair and the twiddle factor, and writing the fourth polynomial coefficient pair into the first polynomial coefficient storage subunit 2351. In the foregoing example, the 1st polynomial coefficient and the 5th polynomial coefficient of the second polynomial coefficient storage subunit 2352 are fetched and used as the third polynomial coefficient pair, and after being processed by using the twiddle factor, become the fourth polynomial coefficient pair. The fourth polynomial coefficient pair is placed back to positions of the 1st polynomial coefficient and the 2nd polynomial coefficient of the first polynomial coefficient storage subunit 2351. This belongs to the second butterfly processing.

The first polynomial coefficient storage subunit 2351 and the second polynomial coefficient storage subunit 2352 each include a plurality of banks 23511, each bank 23511 storing one memory queue sequentially. In the example shown in FIG. 8, the first polynomial coefficient storage subunit 2351 or the second polynomial coefficient storage subunit 2352 includes eight banks 23511 with indexes B1 to B8. Each bank stores a queue of 8 polynomial coefficients. When the ciphertext is expressed as a polynomial of 64 polynomial coefficients, the 64 polynomial coefficients may be distributed in 8 memories, and 8 polynomial coefficients are stored in each bank. polynomial coefficients C0-7 are placed in a bank B1; polynomial coefficients C8-15 are placed in a bank B2; polynomial coefficients C16-23 are placed in a bank B3 . . . , and polynomial coefficients C56-63 are placed in a bank B8. Generally, the number of polynomial coefficients in the polynomial loop may be set to a positive integer power of 2. It is assumed that the number of banks in the first polynomial coefficient storage subunit 2351 or the second polynomial coefficient storage subunit 2352 is M, for example, 8 in the foregoing example, it is equal to a 2 to the 3rd power. In this way, after butterfly processing for multiple times, an order of polynomial coefficients in each bank can be returned to an initial order, and then butterfly processing ends. During fetching of the first polynomial coefficient pair and the third polynomial coefficient pair, two coefficients of a coefficient pair are fetched from two banks far away from each other at equal distance. For example, M banks are divided into first M/2 banks and second m/2 banks, and polynomial coefficients are fetched from the first bank of the first M/2 banks and the first bank of the second m/2 banks, to form one first polynomial coefficient pair; polynomial coefficients are fetched from the second bank of the first M/2 banks and the second bank of the second m/2 banks, to form one first polynomial coefficient pair; . . . ; and so on. In this way, a difference between indexes of banks from which two polynomial coefficients of the polynomial coefficient pair are fetched remains to be M/2. However, indexes of a pair of banks for the first polynomial coefficient pair are the same as indexes of a pair of banks for the third polynomial coefficient pair. For example, during fetching of the first polynomial coefficient pair, the polynomial coefficients are fetched from the first and fifth banks; and during fetching of the third polynomial coefficient pair, the polynomial coefficients are also fetched from the first and fifth banks. In addition, indexes of a pair of banks for the second polynomial coefficient pair are the same as indexes of a pair of banks for the fourth polynomial coefficient pair, and indexes of two banks in the pair of banks are adjacent. For example, the second polynomial coefficient pair is put into the first and second banks after being formed; and the corresponding fourth polynomial coefficient pair is also put into the first and second banks after being formed. After the first butterfly processing, the second butterfly processing is performed, and then the first butterfly processing is performed again, . . . , and so on, until polynomial coefficients are fetched for butterfly processing are returned to its original banks.

Using FIG. 8 as an example, an original sequence of 8 banks in the first polynomial coefficient storage subunit 2351 is B1-8. That is, M=8. There are four butterfly processing subunits 2354. A first butterfly processing subunit 2354 fetches a polynomial coefficient from the bank B1 of the first polynomial coefficient storage subunit 2351 and a polynomial coefficient from the bank B5 of the first polynomial coefficient storage subunit 2351, to form a first polynomial coefficient pair. After processing by using a twiddle factor, a second polynomial coefficient pair is obtained and placed into the banks B1 and B2 of the second polynomial coefficient storage subunit 2352. In this case, the polynomial coefficients placed in the banks B1 and B2 of the second polynomial coefficient storage subunit 2352 are from the banks B1 and B5 of the first polynomial coefficient storage subunit 2351. Likewise, a second butterfly processing subunit 2354 fetches a polynomial coefficient from the bank B2 of the first polynomial coefficient storage subunit 2351 and a polynomial coefficient from the bank B6 of the first polynomial coefficient storage subunit 2351, to form a first polynomial coefficient pair. After processing by using a twiddle factor, a second polynomial coefficient pair is obtained and placed into the banks B3 and B4 of the second polynomial coefficient storage subunit 2352. In this case, the polynomial coefficients placed in the banks B3 and B4 of the second polynomial coefficient storage subunit 2352 are from the banks B2 and B6 of the first polynomial coefficient storage subunit 2351. Derived by analog, after the first butterfly processing, the polynomial coefficients placed in the banks B5 and B6 of the second polynomial coefficient storage subunit 2352 are from the banks B3 and B7 of the first polynomial coefficient storage subunit 2351; and the polynomial coefficients placed in the banks B7 and B8 of the second polynomial coefficient storage subunit 2352 are from the banks B4 and B8 of the first polynomial coefficient storage subunit 2351. Therefore, after the first butterfly processing, content stored in the banks B1-b8 of the second polynomial coefficient storage subunit 2352 is substantially equivalent to that in the banks B1, B5, B2, B6, B3, B7, B4, and B8 of the original first polynomial coefficient storage subunit 2351.

In the second butterfly processing, the first butterfly processing subunit 2354 fetching the polynomial coefficients stored in the first and fifth banks of the second polynomial coefficient storage subunit 2352 is actually fetching the polynomial coefficients from the original banks B1 and B3, as the third polynomial coefficient pair. After processing by using a twiddle factor, a fourth polynomial coefficient pair is obtained and placed into the first and second banks of the first polynomial coefficient storage subunit 2351. At this time, the polynomial coefficients placed in the banks B1 and B2 of the first polynomial coefficient storage subunit 2351 are substantially content of the original banks B1 and B3. Likewise, after processing by the second to fourth butterfly processing subunits 2354, the polynomial coefficients placed in the banks B3 and B4 of the first polynomial coefficient storage subunit 2351 are substantially content of the original banks B5 and B7; the polynomial coefficient placed in the banks B5 and B6 of the first polynomial coefficient storage subunit 2351 are substantially content of the original banks B2 and B4; and the polynomial coefficient placed in the banks B7 and B8 of the first polynomial coefficient storage subunit 2351 are substantially content of the original banks B2 and B4. After the second butterfly processing, content stored in the banks B1-B8 of the first polynomial coefficient storage subunit 2351 is substantially equivalent to that in the original banks B1, B3, B5, B7, B2, B4, B6, and B8, respectively.

Then, after the first butterfly processing for one time, content stored in the banks B1-B8 of the second polynomial coefficient storage subunit 2352 is substantially equivalent to that in the banks B1, B2, B3, B4, B5, B6, B7, and B8 of the original first polynomial coefficient storage subunit 2351, respectively. In this case, according to the general butterfly processing principle, processing can be stopped after butterfly processing for log₂ M times, and the polynomial coefficients stored in these banks become a processing result of number theoretic transform.

It can be seen that in the foregoing process, for a single butterfly processing subunit 2354 (the first, second, third, or fourth butterfly processing subunit 2354), the indexes of the banks, from which the butterfly processing subunit 2354 fetches the first polynomial coefficient pair, in the first polynomial coefficient storage subunit 2351 in the first butterfly processing (for example, B1 and B5 of the first butterfly processing subunit, B2 and B6 of the second butterfly processing subunit, B3 and B7 of the third butterfly processing subunit, and B4 and B8 of the fourth butterfly processing subunit) are consistent with the indexes of the banks, from which the butterfly processing subunit 2354 fetches the third polynomial coefficient pair, in the second polynomial coefficient storage subunit 2352 in the second butterfly processing. Such consistent read/write manner can alleviate pressure of layout and wiring. In addition, a difference between the indexes of the fetched-from banks is M/2 (for example, there is a difference 4 between 1 and 5, between 2 and 6, between 3 and 7, or between 4 and 8). A single butterfly processing subunit 2354 makes the indexes of the banks into which the generated second polynomial coefficient pair is placed into the second polynomial coefficient storage subunit 2352 during first butterfly processing (for example, B1 and B2 of the first butterfly processing subunit, B3 and B4 of the second butterfly processing subunit, B5 and B6 of the third butterfly processing subunit, and B7 and B8 of the fourth butterfly processing subunit) to be consistent with the indexes of the banks into which the generated fourth polynomial coefficient pair is placed into the first polynomial coefficient storage subunit 2351 during second butterfly processing. In addition, the indexes of the banks in which they are placed are adjacent. Only in this way can the order of the banks in which the polynomial coefficients are stored is returned to an initial state after several times of butterfly processing, for example, B1, B2, B3, B4, B5, B6, B2, B3, B4, B5, B6, B7, and B8 in the foregoing example, that is, being returned to the initial state after butterfly processing for log₂ M times, so as to satisfy a termination condition for number theoretic transform in general sense.

That described above is only a termination condition for number theoretic transform in general sense. In the embodiments of the present disclosure, after the termination condition for number theoretic transform in general sense is satisfied, the control unit 2355 transposes the first polynomial coefficient storage subunit 2351 or the second polynomial coefficient storage subunit 2352, and then the butterfly processing subunit 2354 performs first butterfly processing or second butterfly processing for log₂ M times, that is, on the basis of transposition, the termination condition for number theoretic transform in general sense is satisfied again.

The transposing includes: fetching before-transposing polynomial coefficients queuing in a same serial number in the banks of the first polynomial coefficient storage subunit 2351 or the second polynomial coefficient storage subunit 2352, and placing the after-transposing polynomial coefficients into one bank 23511 in an order of bank indexes. That is, rows and columns of an array of the polynomial coefficients in the first polynomial coefficient storage subunit 2351 or the second polynomial coefficient storage subunit 2352 are reversed. The original columns (of the bank 23511) are used as rows of the new array (polynomial coefficients of the same serial number in all the banks 23511), and the original rows (polynomial coefficients of the same serial number in all the banks 23511) are used as columns of the new array (of the bank 23511). As shown in FIG. 8, polynomial coefficients C0, C8, C16, C24, C32, C40, C48, and C56 located in the first positions of queues of banks B1-B8 of the original first polynomial coefficient storage subunit 2351 are stored in an ascending order in an after-transposing bank B1; polynomial coefficients C1, C9, C17, C25, C33, C41, C49, and C57 located in the second positions of queues of banks B1-B8 of the original first polynomial coefficient storage subunit 2351 are stored in an ascending order in an after-transposing bank B2; polynomial coefficients C2, C10, C18, C26, C34, C42, C50, and C58 located in the third positions of queues of banks B1-B8 of the original first polynomial coefficient storage subunit 2351 are stored in an ascending order in an after-transposing bank B3; . . . ; and polynomial coefficients C7, C15, C23, C31, C39, C47, C55, and C63 located in the last positions of queues of banks B1-B8 of the original first polynomial coefficient storage subunit 2351 are stored in an ascending order in an after-transposing bank B8.

After transposing is performed, the butterfly processing subunit 2354 performs first butterfly processing or second butterfly processing for log₂ M times again. Because the process is exactly the same as the process before transposing, details are not described for brevity.

A function of the transposing in the embodiment of the present disclosure is as follows: If transposing is not performed, the butterfly processing subunit 2354 keeps performing butterfly processing on polynomial coefficients 235111 in two different banks 23511. However, in practice, it is sometimes necessary to perform butterfly processing on different polynomial coefficients 235111 in the same bank 23511. Therefore, transposing is introduced. Two polynomial coefficients for butterfly processing are from different banks 23511 before transposing. After transposing, two polynomial coefficients for butterfly processing are from a low bit and a high bit of the same original bank 23511. For example, 8 polynomial coefficients 235111 in the bank 23511 are queued, the first four polynomial coefficients 235111 being lower bits and the last four polynomial coefficients being higher bits. In this way, read/write is repeatedly performed on polynomial coefficients in higher and lower bits of the same bank, spreading an application scope of butterfly processing.

Internal Structure of the Butterfly Processing Subunit

As shown in FIG. 5, the butterfly processing subunit 2354 according to an embodiment of the present disclosure includes a first multi-path gating selector 23541, a second multi-path gating selector 23542, a third multi-path gating selector 23543, a fourth multi-path gating selector 23544, a first adder 23545, a second adder 23546, a first subtractor 23547, a second subtractor 23548, and a first multiplier 23549. Each multi-path gating selector in FIG. 3 has a first input terminal (input terminal 0), a second input terminal (input terminal 1), a control terminal, and an output terminal. The control terminal is connected to a control signal SEL or non-SEL. When SEL is set to 1, the second input terminal (input terminal 1) is on, and its signal directly enters the output terminal. When SEL is set to 0, the first input terminal (input terminal 0) is on, and its signal directly enters the output terminal. Which one of the first input terminal and the second input terminal is output is determined by whether a signal connected to the control terminal is set to 0 or 1.

As shown in FIG. 5, a first coefficient 301 of the first polynomial coefficient pair or the third polynomial coefficient pair is input to the first input terminal (input terminal 0) of the first multi-path gating selector 23541; after being added by the first adder 23545 to a second coefficient 302 of the first polynomial coefficient pair or the third polynomial coefficient pair, is input to the second input terminal (input terminal 1) of the first multi-path gating selector 23541; and one of the first input terminal and the second input terminal is selected by a first gating signal (non-SEL) of the first multi-path gating selector 23541 to connect to the output terminal. The second coefficient 302 is input to a second input terminal (input terminal 1) of the third multi-path gating selector 23543; after subtraction is performed on the second coefficient 302 and the first coefficient 301 by the first subtractor 23547, is input to a first input terminal (input terminal 0) of the third multi-path gating selector 23543; and one of the first input terminal and the second input terminal is selected by using a third gating signal (non-SEL) of the third multi-path gating selector 23543 to connect to an output terminal, and is multiplied with a corresponding twiddle factor by the first multiplier 23549 to obtain a product signal.

A signal output from an output terminal of the first multi-path gating selector 23541 is input to a first input terminal (input terminal 0) of the second multi-path gating selector 23542, and after being added to the product signal by the second adder 23546, is input to a second input terminal (input terminal 1) of the second multi-path gating selector 23542; and one of the first input terminal and the second input terminal is selected by using a second gating signal (SEL) of the second multi-path gating selector 23542 to connect to an output terminal as one coefficient 303 of the second polynomial coefficient pair or fourth polynomial coefficient pair. The product signal is input to a second input terminal (input terminal 1) of the fourth multi-path gating selector 23544, and after subtraction is performed by the second subtractor 23548 on the product signal and the signal output from the first multi-path gating selector, is input to a first input terminal (input terminal 0) of the fourth multi-path gating selector 23544; and one of the first input terminal and the second input terminal is selected by using a fourth gating signal (SEL) of the fourth multi-path gating selector 23544 to connect to an output terminal as the other coefficient 304 of the second polynomial coefficient pair or fourth polynomial coefficient pair.

In the foregoing structure, if SEL=1, and non-SEL is equal to 0, the first input terminals (input terminal 0) of the first multi-path gating selector 23541 and the third multi-path gating selector 23543 are on, a signal output by the first multi-path gating selector 23541 is the first coefficient 301, and a signal output by the third multi-path gating selector 23543 is (second coefficient 302−first coefficient 301), so as to obtain, through processing by the first multiplier 23549, a product signal=(second coefficient 302−first coefficient 301)×twiddle factor. Because SEL=1, the second input terminals (input terminal 1) of the second multi-path gating selector 23542 and the fourth multi-path gating selector 23544 are on, a signal output by the second multi-path gating selector 23542 is first coefficient 301+product signal=first coefficient 301+(second coefficient 302−first coefficient 301)×twiddle factor=first coefficient 301×(1−twiddle factor)+second coefficient 302×twiddle factor, and a signal outputted by the fourth multi-path gating selector 23544 is the product signal=(second coefficient 302−first coefficient 301)×twiddle factor. The foregoing formulas for the outputs 303 and 304 are just consistent with the requirements of number theoretic transform, that is, when SEL=1, number theoretic transform can be performed by using the foregoing structure.

In the foregoing structure, if SEL=0, and non-SEL is equal to 1, the second input terminals (input terminal 1) of the first multi-path gating selector 23541 and the third multi-path gating selector 23543 are on, a signal output by the first multi-path gating selector 23541 is: (first coefficient 301+second coefficient 302), and a signal output by the third multi-path gating selector 23543 is the second coefficient 302, so as to obtain, through processing by the first multiplier 23549, a product signal=second coefficient 302×twiddle factor. Because non-SEL is 0, the first input terminals (input terminal 0) of the second multi-path gating selector 23542 and the fourth multi-path gating selector 23544 are on, a signal output by the second multi-path gating selector 23542 is: (first coefficient 301+second coefficient 302), a signal output by the fourth multi-path gating selector 23544 is: product signal−(first coefficient 301+second coefficient 302)=second coefficient 302×(twiddle factor−1)−first coefficient 301. The foregoing formulas for the outputs 303 and 304 are just consistent with the requirements of inverse number theoretic transform, that is, when SEL=0, inverse number theoretic transform can be performed by using the foregoing structure.

In the foregoing embodiment, with the simple structure, number theoretic transform and inverse number theoretic transform are implemented, thereby improving implementation efficiency of number theoretic transform and inverse number theoretic transform.

The structure of the butterfly processing subunit 2354 is merely an example, and there may be other structures for implementing number theoretic transform and inverse number theoretic transform.

Internal Structure of the Arithmetic Logic Unit

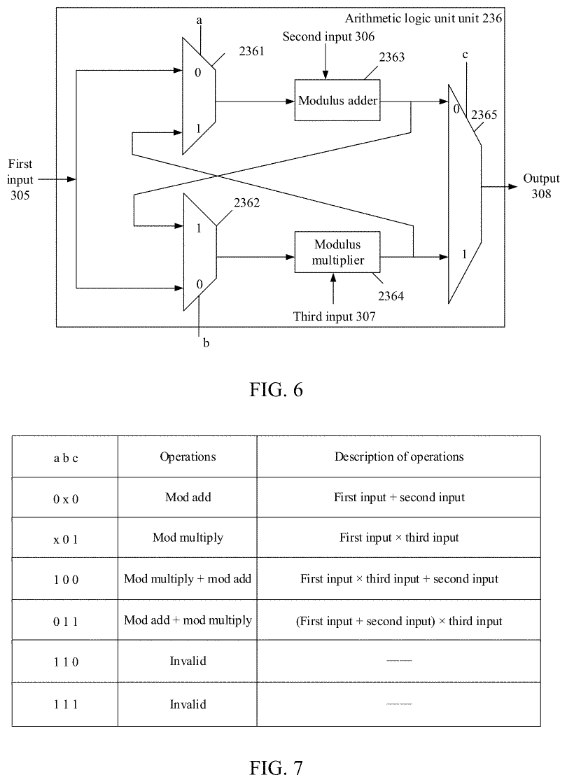

As shown in FIG. 6, an arithmetic logic unit 236 according to an embodiment of the present disclosure includes a modulus adder 2363, a modulus multiplier 2364, a fifth multi-path gating selector 2361, a sixth multi-path gating selector 2362, and a seventh multi-path gating selector 2365. Each multi-path gating selector has a first input terminal (input terminal 0), a second input terminal (input terminal 1), a control terminal, and an output terminal. The control terminal is connected to a control signal a, b, or c for the respective multi-path gating selector 2361, 2362, 2365. When the control signal a, b, or c is set to 1, the second input terminal (input terminal 1) is on, and its signal directly enters the output terminal. When the control signal a, b, or c is set to 0, the first input terminal (input terminal 0) is on, and its signal directly enters the output terminal. Which one of the first input terminal and the second input terminal is output is determined by whether a signal connected to the control terminal is set to 0 or 1.

As shown in FIG. 6, a first input signal 305 is input to first input terminals (input terminal 0) of the fifth multi-path gating selector 2361 and the sixth multi-path gating selector 2362. An output terminal of the modulus adder 2363 is input to a second input terminal (input terminal 1) of the sixth multi-path gating selector 2362. An output terminal of the modulus multiplier 2364 is input to a second input terminal (input terminal 1) of the fifth multi-path gating selector 2361. One of the first input terminal (input terminal 0) and the second input terminal (input terminal 1) of the fifth multi-path gating selector 2361 is selected by using a fifth gating signal a of the fifth multi-path gating selector 2361 to connect to the respective output terminal; and one of the first input terminal (input terminal 0) and the second input terminal (input terminal 1) of the sixth multi-path gating selector 2362 is selected by using a sixth gating signal b of the sixth multi-path gating selector 2362 to connect to the respective output terminal. The output terminal of the fifth multi-path gating selector 2361 is connected to a first input terminal of the modulus adder 2363, and a second input signal 306 is input to a second input terminal of the modulus adder 2363. The modulus adder 2363 performs modulus add on an input signal of the first input terminal and an input signal of the second input terminal, and outputs a result through its output terminal. An output terminal of the sixth multi-path gating selector 2362 is connected to a first input terminal of the modulus multiplier 2364, and a third input signal 307 is input to a second input terminal of the modulus multiplier 2364. An output terminal of the modulus adder 2363 is connected to a first input terminal (input terminal 0) of the seventh multi-path gating selector 2365, an output terminal of the modulus multiplier 2364 is connected to a second input terminal (input terminal 1) of the seventh multi-path gating selector 2365, and one of the first input terminal (input terminal 0) and the second input terminal (input terminal 1) of the seventh multi-path gating selector 2365 is selected by using a seventh gating signal c of the seventh multi-path gating selector 2365 to connect to an output terminal 308.

With the foregoing circuit structure, the fifth, sixth, and seventh signals a, b, and c of the fifth, sixth, and seventh multi-path gating selectors 2361, 2362, and 2365 are differently set. The arithmetic logic unit 236 in FIG. 6 is capable of implementing modulus add, modulus multiply, and operations of different combinations thereof.

As shown in FIG. 6, when the fifth gating signal a is set to 0, that is the first input terminal (input terminal 0) is selected, and when the seventh gate signal C is set to 0, that is, the first input terminal (input terminal 0) is selected, the output 308 of the seventh multi-path gating selector 2365 is equal to the input of the first input terminal (input terminal 0), and the input is a modulus add result by the modulus adder 2363. The two inputs of the modulus adder 2363 are the output of the fifth multi-path gating selector 2361 and the second input 306. The output of the fifth multi-path gating selector 2361 is equal to the first input 305 of the first input terminal of the fifth multi-path gating selector 2361 because the fifth gating signal a is set to 0. In this way, the output of the modulus adder 2363 is equal to the first input 305+second input 306, so that the output of the arithmetic logic unit 236 is also equal to the first input 305+second input 306. Therefore, with the fifth gating signal a being set to 0 and the seventh gating signal c being set to 0, the arithmetic logic unit 236 completes the modulus add function, as shown in FIG. 7.

As shown in FIG. 6, when the sixth gating signal b is set to selecting the first input terminal (input terminal 0) and the seventh gate signal c is set to selecting the second input terminal (input terminal 1), the output 308 of the seventh multi-path gating selector 2365 is equal to the input of the second input terminal (input terminal 1). The input is a modulus multiply result by the modulus multiplier 2364. The two inputs of the modulus multiplier 2364 are the output of the sixth multi-path gating selector 2362 and the third input 307. The output of the sixth multi-path gating selector 2362 is equal to the first input 305 of the first input terminal (input terminal 0) of the sixth multi-path gating selector 2362 because the sixth gating signal b is set to 0. In this way, the output of the modulus multiplier 2364 is equal to the first input 305×third input 307, so that the output of the arithmetic logic unit 236 is also equal to the first input 305×third input 307. Therefore, with the sixth gating signal b being set to 0 and the seventh gating signal c being set to 1, the arithmetic logic unit 236 completes the modulus multiply function, as shown in FIG. 7.

As shown in FIG. 6, when the fifth gating signal a is set to selecting the second input terminal (input terminal 1), the sixth gate signal b is set to selecting the first input terminal (input terminal 0), and the seventh gate signal c is set to selecting the first input terminal (input terminal 0), the output 308 of the seventh multi-path gating selector 2365 is equal to the input of the first input terminal (input terminal 0). The input is a modulus add result by the modulus adder 2363. The two inputs of the modulus adder 2363 are the output of the fifth multi-path gating selector 2361 and the second input 306. Therefore, the output 308 of the arithmetic logic unit 236=output the fifth multi-path gating selector 2361+second input 306. Because the fifth gating signal a is set to selecting the second input terminal (input terminal 1), the output of the fifth multi-path gating selector 2361 is equal to the input of its second input terminal (input terminal 1), and the input is the output of the modulus multiplier 2364. The output of the modulus multiplier 2364 is equal to the output of the sixth multi-path gating selector 2362×third input 307. Because the sixth gating signal b is set to selecting the first input terminal (input terminal 0), the output of the sixth multi-path gating selector 2362 is equal to the input of the first input terminal (input terminal 0), that is, the first input 305; therefore, the output of the fifth multi-path gating selector 2361 is equal to the first input 305×third input 307. In this way, the output 308=first input 305×third input 307+second input 306. The arithmetic logic unit 236 performs modulus multiply, and then performs modulus add, as shown in FIG. 7.

As shown in FIG. 6, when the fifth gating signal a is set to selecting the first input terminal (input terminal 0), the sixth gate signal b is set to selecting the second input terminal (input terminal 1), and the seventh gate signal c is set to selecting the second input terminal (input terminal 1), the output 308 of the seventh multi-path gating selector 2365 is equal to the input of the second input terminal (input terminal 1). The input is a modulus multiply result by the modulus multiplier 2364. The two inputs of the modulus multiplier 2364 are the output of the sixth multi-path gating selector 2362 and the third input 307. Therefore, the output 308 of the arithmetic logic unit 236=output the sixth multi-path gating selector 2362+third input 307. Because the sixth gating signal b is set to selecting the second input terminal (input terminal 1), the output of the sixth multi-path gating selector 2362 is equal to the input of its second input terminal (input terminal 1), and the input is the output of the modulus adder 2363. The output of the modulus adder 2363 is equal to the output of the fifth multi-path gating selector 2361+second input 306. Because the fifth gating signal a is set to selecting the first input terminal (input terminal 0), the output of the fifth multi-path gating selector 2361 is equal to the input of the first input terminal (input terminal 0), that is, the first input 305; therefore, the output of the sixth multi-path gating selector 2362 is equal to the first input 305×second input 306. In this way, the output 308=(first input 305+second input 306)×third input 307. The arithmetic logic unit 236 performs modulus add, and then performs modulus multiply, as shown in FIG. 7.

As shown in FIG. 6, when the fifth gating signal a is set to selecting the second input terminal (input terminal 1), the sixth gate signal b is set to selecting the second input terminal (input terminal 1), and the seventh gate signal c is set to selecting the first input terminal (input terminal 0), the circuit cannot perform any operation, that is, being invalid, as shown in FIG. 7. Likewise, when the fifth gating signal a is set to selecting the second input terminal (input terminal 1), the sixth gate signal b is set to selecting the second input terminal (input terminal 1), and the seventh gate signal c is set to selecting the second input terminal (input terminal 1), the circuit cannot perform any operation, that is, being invalid, as shown in FIG. 7.

With the above simple circuit, the gating signals a, b, and c can be set to form different combinations, so that the arithmetic logic unit 236 can implement different combinations of modulus add and modulus multiply operations, to implement a variety of arithmetic logic operations, thereby improving efficacy of the circuit.

Processes of a Deep Neural Network Running Method According to the Embodiments of the Present Disclosure

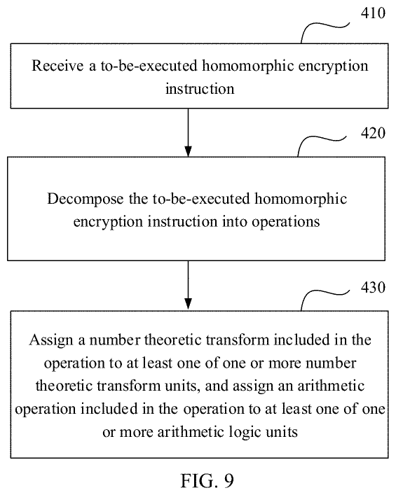

As shown in FIG. 9, an embodiment of the present disclosure provides a homomorphic encryption method, including:

Step 410: Receive a to-be-executed homomorphic encryption instruction.

Step 420: Decompose the to-be-executed homomorphic encryption instruction into operations.

Step 430: Assign a number theoretic transform included in the operation to at least one of one or more number theoretic transform units, and assign an arithmetic operation included in the operation to at least one of one or more arithmetic logic units.

Implementation details of the foregoing process have been described in detail in the foregoing apparatus embodiments, and therefore are not repeated herein.

Commercial Values of the Embodiments of the Present Disclosure

Experiments prove that a general-purpose, modular, and scalable architecture homomorphic encryption accelerator provided in the embodiment of the present disclosure greatly reduces deployment costs for homomorphic encryption algorithms and redeployment costs for subsequently changing the algorithms up to 50% to 80%, and therefore has good market prospects.

It should be understood that the embodiments in this specification are described in a progressive manner, the same or similar parts of the embodiments are referred to each other, and each embodiment focuses on differences from other embodiments. Especially, a method embodiment is basically similar to a method described in the apparatus and system embodiments, and therefore is described briefly; for related parts, reference may be made to partial descriptions in the other embodiments.

It should be understood that the specific embodiments of this specification are described above. Other embodiments fall within the scope of the claims. In some cases, actions or steps described in the claims may be performed in an order different from that in the embodiments, and may still implement desired results. In addition, the processes described in the accompanying drawings are not necessarily performed in an illustrated particular order or sequentially to implement the desired results. In some embodiments, multi-task processing and parallel processing are also acceptable or may be advantageous.

It should be understood that providing descriptions in a singular form in this specification or showing only one component in the accompanying drawings does not mean limiting a quantity of components to one. In addition, the separate modules or components described or shown in this specification may be combined into a single module or component, and a single module or component described or shown in this specification may be split into a plurality of modules or components.

It should be further understood that the terms and expressions used herein are intended only for description, and that one or more embodiments of this specification should not be limited to those terms and expressions. Use of these terms and expressions does not imply exclusion of equivalent features of any indication and description (or a part thereof), and it should be recognized that any possible modifications should also fall within the scope of the claims. Other modifications, changes, and replacements may also exist. Correspondingly, the claims shall be considered to cover all these equivalents.

1. An acceleration unit, comprising:
one or more number theoretic transform units adapted to perform number theoretic transform during homomorphic encryption;
one or more arithmetic logic units adapted to perform arithmetic operations during homomorphic encryption; and
a scheduler adapted to assign operations in a to-be-executed homomorphic encryption instruction to at least one of the one or more number theoretic transform units and at least one of the one or more arithmetic logic units.

2. The acceleration unit according to claim 1, further comprising:
an instruction buffer adapted to receive a control signal, wherein the control signal comprises the to-be-executed homomorphic encryption instruction;
an instruction fetch unit adapted to fetch the to-be-executed homomorphic encryption instruction from the instruction buffer; and
an instruction decoding unit adapted to decode the to-be-executed homomorphic encryption instruction fetched by the instruction fetch unit and send to the scheduler the to-be-executed homomorphic encryption instruction that has been decoded.

3. The acceleration unit according to claim 2, wherein:
the control signal further comprises an access memory address; and
the acceleration unit further comprises:
a memory interface for performing data transmission with a memory; and
a direct memory access unit adapted to receive an access memory address sent by the instruction buffer, and indicate the memory interface to fetch, according to the access memory address, data required by the to-be-executed homomorphic encryption instruction.

4. The acceleration unit according to claim 1, wherein the scheduler divides the to-be-executed homomorphic encryption instruction into at least one of the following: modulus multiply operation, modulus add operation, number theoretic transform, inverse number theoretic transform, modulus switch, key switch, and rescale.

5. The acceleration unit according to claim 4, wherein the scheduler assigns the modulus multiply operation or modulus add operation to at least one of the one or more arithmetic logic units.

6. The acceleration unit according to claim 4, wherein the scheduler assigns the number theoretic transform to at least one of the one or more number theoretic transform units.

7. The acceleration unit according to claim 4, wherein for the inverse number theoretic transform, the scheduler decomposes the inverse number theoretic transform into a combination of a number theoretic transform and a modulus multiply operation, and assigns the number theoretic transform resulting from decomposition to at least one of the one or more number theoretic transform units, and assigns the modulus multiply operation resulting from decomposition to at least one of the one or more arithmetic logic units.

8. The acceleration unit according to claim 7, wherein for the modulus switch, the scheduler decomposes the modulus switch into a combination of a modulus add and a modulus multiply, and assigns the decomposition result to at least one of the one or more arithmetic logic units.

9. The acceleration unit according to claim 8, wherein for the key switch, the scheduler decomposes the key switch into a combination of a number theoretic transform, an inverse number theoretic transform, a modulus multiply, and a modulus switch, and assigns the decomposition result to at least one of the one or more number theoretic transform units or at least one of the one or more arithmetic logic units.

10. The acceleration unit according to claim 8, wherein for the rescale, the scheduler decomposes the rescale into a combination of a number theoretic transform, an inverse number theoretic transform, and a modulus switch, and assigns the decomposition result to at least one of the one or more number theoretic transform units or at least one of the one or more arithmetic logic units.

11. The acceleration unit according to claim 1, wherein at least one of the one or more number theoretic transform units comprises:
a first polynomial coefficient storage subunit;
a second polynomial coefficient storage subunit;
a twiddle factor storage subunit adapted to store a twiddle factor for the number theoretic transform; and
a butterfly processing subunit adapted to perform first butterfly processing and second butterfly processing, wherein the first butterfly processing comprises: reading a first polynomial coefficient pair from the first polynomial coefficient storage subunit, obtaining a twiddle factor corresponding to the first polynomial coefficient pair from the twiddle factor storage subunit, obtaining a second polynomial coefficient pair based on the first polynomial coefficient pair and the twiddle factor, and writing the second polynomial coefficient pair into the second polynomial coefficient storage subunit; and the second butterfly processing comprises: reading a third polynomial coefficient pair from the second polynomial coefficient storage subunit, obtaining a twiddle factor corresponding to the third polynomial coefficient pair from the twiddle factor storage subunit, obtaining a fourth polynomial coefficient pair based on the third polynomial coefficient pair and the twiddle factor, and writing the fourth polynomial coefficient pair into the first polynomial coefficient storage subunit.

12. The acceleration unit according to claim 11, wherein at least one of the one or more number theoretic transform units further comprises: a control unit adapted to control running of the first polynomial coefficient storage subunit, the second polynomial coefficient storage subunit, the twiddle factor storage subunit, and the butterfly processing subunit.

13. The acceleration unit according to claim 11, wherein the first polynomial coefficient storage subunit and the second polynomial coefficient storage subunit each comprise a plurality of banks, each bank having a corresponding index, the first polynomial coefficient pair and the third polynomial coefficient pair are from banks with a same index, and the second polynomial coefficient pair and the fourth polynomial coefficient pair are from banks with a same index.

14. The acceleration unit according to claim 13, wherein M banks are comprised in the first polynomial coefficient storage subunit or the second polynomial coefficient storage subunit, and there are m/2 butterfly processing subunits; and for a single butterfly processing subunit, indexes of a pair of banks for the first polynomial coefficient pair are the same as indexes of a pair of banks for the third polynomial coefficient pair, and a difference between indexes of two banks in the pair of banks is m/2; and indexes of a pair of banks for the second polynomial coefficient pair are the same as indexes of a pair of banks for the fourth polynomial coefficient pair, and indexes of two banks in the pair of banks are adjacent.

15. The acceleration unit according to claim 14, wherein after log₂ M times of first butterfly processing or second butterfly processing, the control unit transposes the first polynomial coefficient storage subunit or the second polynomial coefficient storage subunit, and then the butterfly processing subunit performs the first butterfly processing or the second butterfly processing for log₂ M times again, wherein the transposing comprises: fetching before-transposing polynomial coefficients queuing in a same serial number in the banks of the first polynomial coefficient storage subunit or the second polynomial coefficient storage subunit, and placing the after-transposing polynomial coefficients into one bank in an order of bank indexes.

16. The acceleration unit according to claim 11, wherein the butterfly processing subunit comprises a first multi-path gating selector, a second multi-path gating selector, a third multi-path gating selector, a fourth multi-path gating selector, a first adder, a second adder, a first subtractor, a second subtractor, and a first multiplier.

17. The acceleration unit according to claim 16, wherein a first coefficient of the first polynomial coefficient pair or third polynomial coefficient pair is input to a first input terminal of the first multi-path gating selector, and after being added to a second coefficient of the first polynomial coefficient pair or third polynomial coefficient pair by the first adder, is input to a second input terminal of the first multi-path gating selector; one of the first input terminal and the second input terminal is selected by using a first gating signal of the first multi-path gating selector to connect to an output terminal; the second coefficient is input to a second input terminal of the third multi-path gating selector, and after subtraction is performed on the second coefficient and the first coefficient by the first subtractor, is input to a first input terminal of the third multi-path gating selector; and one of the first input terminal and the second input terminal is selected by using a third gating signal of the third multi-path gating selector to connect to an output terminal, and is multiplied with a corresponding twiddle factor by the first multiplier to obtain a product signal.

18. The acceleration unit according to claim 16, wherein a signal output from an output terminal of the first multi-path gating selector is input to a first input terminal of the second multi-path gating selector, and after being added to the product signal by the second adder, is input to a second input terminal of the second multi-path gating selector; one of the first input terminal and the second input terminal is selected by using a second gating signal of the second multi-path gating selector to connect to an output terminal as one coefficient of the second polynomial coefficient pair or fourth polynomial coefficient pair; the product signal is input to a second input terminal of the fourth multi-path gating selector, and after subtraction is performed by the second subtractor on the product signal and the signal output from the first multi-path gating selector, is input to a first input terminal of the fourth multi-path gating selector; and one of the first input terminal and the second input terminal is selected by using a fourth gating signal of the fourth multi-path gating selector to connect to an output terminal as the other coefficient of the second polynomial coefficient pair or fourth polynomial coefficient pair.

19. The acceleration unit according to claim 1, wherein the arithmetic logic unit comprises a modulus adder, a modulus multiplier, a fifth multi-path gating selector, a sixth multi-path gating selector, and a seventh multi-path gating selector, wherein a first input signal is input to a first input terminal of the fifth multi-path gating selector and a first input terminal of the sixth multi-path gating selector, an output of the modulus adder is input to a second input terminal of the sixth multi-path gating selector, an output of the modulus multiplier is input to a second input terminal of the fifth multi-path gating selector, one of the first input terminal and the second input terminal of the fifth multi-path gating selector is selected by using a fifth gating signal of the fifth multi-path gating selector to connect to an output terminal, one of the first input terminal and the second input terminal of the sixth multi-path gating selector is selected by using a sixth gating signal of the sixth multi-path gating selector to connect to an output terminal; the output terminal of the fifth multi-path gating selector is connected to a first input terminal of the modulus adder, and a second input signal is input to a second input terminal of the modulus adder; an output terminal of the sixth multi-path gating selector is connected to a first input terminal of the modulus multiplier, and a third input signal is input to a second input terminal of the modulus multiplier; an output terminal of the modulus adder is connected to a first input terminal of the seventh multi-path gating selector, an output terminal of the modulus multiplier is connected to a second input terminal of the seventh multi-path gating selector, and one of the first input terminal and the second input terminal of the seventh multi-path gating selector is selected by using a seventh gating signal of the seventh multi-path gating selector to connect to an output terminal.

20. The acceleration unit according to claim 19, wherein the fifth gating signal is set to selecting a first input terminal, the seventh gating signal is set to selecting a first input terminal, and the arithmetic logic unit is adapted to perform a modulus add operation.

21. The acceleration unit according to claim 19, wherein the sixth gating signal is set to selecting a first input terminal, the seventh gating signal is set to selecting a second input terminal, and the arithmetic logic unit is adapted to perform a modulus multiply operation.

22. The acceleration unit according to claim 19, wherein the fifth gating signal is set to selecting a second input terminal, the sixth gating signal is set to selecting a first input terminal, the seventh gating signal is set to selecting a first input terminal, and the arithmetic logic unit is adapted to perform a modulus multiply operation and then perform a modulus add operation.

23. The acceleration unit according to claim 19, wherein the fifth gating signal is set to selecting a first input terminal, the sixth gating signal is set to selecting a second input terminal, the seventh gating signal is set to selecting a second input terminal, and the arithmetic logic unit is adapted to perform a modulus add operation and then perform a modulus multiply operation.

24. A homomorphic encryption method, comprising:
receiving a to-be-executed homomorphic encryption instruction;
decomposing the to-be-executed homomorphic encryption instruction into operations; and
assigning number theoretic transform comprised in the operation to at least one of one or more number theoretic transform units, and assigning arithmetic operation comprised in the operation to at least one of one or more arithmetic logic units.
